(19) United States
(12) Patent Application Publication
(10) Pub. No.: US 2020/0311677 A1
(43) Pub. Date: Oct. 1, 2020

(54) DELIVERY ARRANGEMENT SYSTEM AND DELIVERY ARRANGEMENT METHOD

(71) Applicant: HONDA MOTOR CO., LTD., Tokyo (JP)

(72) Inventors: Yasushi Ikeuchi, Wako-shi (JP); Takeyuki Suzuki, Wako-shi (JP); Naoko Imai, Wako-shi (JP); Shinya Uchiyama, Wako-shi (JP)

(21) Appl. No.: 16/816,696

(22) Filed: Mar. 12, 2020

(30) Foreign Application Priority Data
Mar. 25, 2019 (JP) 2019-056278

(51) Int. Cl. G06Q 10/08; G06Q 30/02; G06Q 50/30; H04W 4/029

(52) U.S. Cl. CPC G06Q 10/08355; G06Q 10/0832; H04W 4/029; G06Q 50/30; G06Q 30/0235

(57) ABSTRACT

In a delivery arrangement system that arranges delivery of an article from a provider of the article to a predetermined place, a first delivery request acceptance section receives, from a first user terminal used by a first user located in the predetermined place or heading for the predetermined place, first delivery request information that requests delivery of the article to the predetermined place, and accepts a first delivery request that is a request made by the first user for delivery of the article to the predetermined place. A second user extraction section extracts a second user located in the predetermined place or heading for the predetermined place when the first delivery request is accepted. A delivery offer section transmits, to a second user terminal used by the second user, delivery offer information that gives information related to delivery of the article to the predetermined place.

### INCORPORATION BY REFERENCE

The present application claims priority under 35 U.S.C. § 119 to Japanese Patent Application No. 2019-056278 filed on Mar. 25, 2019. The content of the application is incorporated herein by reference in its entirety.

### BACKGROUND OF THE INVENTION

### Field of the Invention

The present invention relates to a delivery arrangement system and a delivery arrangement method.

### Description of the Related Art

Conventionally, a system has been provided that transmits, to a user terminal used in a vehicle traveling on a so congested road that it is expected to take a given time period or longer to pass the road, an offer screen for accepting an order for delivery of food and drink to the vehicle (for example, see Japanese Patent Laid-Open No. 2006-72499).

In the system, when a user having checked the offer screen orders delivery of food and drink, a food and drink vendor is extracted that is located nearest to a projected position of the vehicle at a desired delivery time. Then, a menu screen of food and drink items provided by the extracted food and drink vendor is transmitted to the user terminal to allow the user to select a food or drink item.

In a case of transmitting a food and drink menu screen to a user located in a specific place such as a congested road and accepting an order for delivery as in the conventional system described above, when there is a rush of orders for delivery from users, delivery needs to be performed by frequently traveling back and forth between a provider of food and drink and the specific place to respond to each order. Accordingly, there is a disadvantage that delivery is inefficient.

An aspect of the present invention is made in light of such a background, and an object of the present invention is to provide a delivery arrangement system and a delivery arrangement method that can enhance efficiency in delivery to a plurality of delivery destinations within a predetermined place.

### SUMMARY OF THE INVENTION

An aspect to achieve the above object can be a delivery arrangement system that arranges delivery of an article from a provider of the article to a predetermined place, including: a first delivery request acceptance section that receives, from a first user terminal used by a first user located in the predetermined place or heading for the predetermined place, first delivery request information that requests delivery of the article to the predetermined place, and accepts a first delivery request that is a request made by the first user for delivery of the article to the predetermined place; a second user extraction section that extracts a second user located in the predetermined place or heading for the predetermined place when the first delivery request is accepted by the first delivery request acceptance section; and a delivery offer section that transmits, to a second user terminal used by the second user extracted by the second user extraction section, delivery offer information that gives information related to delivery of the article to the predetermined place.

According to the delivery arrangement system, when the request made by the first user for delivery of the article to the predetermined place is accepted by the first delivery request acceptance section, delivery of the article to the predetermined place is offered by the delivery offer section to the second user located in the predetermined place or heading for the predetermined place. With the offer, a request made by the second user for delivery to the predetermined place can be accepted collectively with delivery to the predetermined place based on the already accepted request of the first user. The provider of the article can take an action of delivering the article requested by the first user and the article requested by the second user to the predetermined place in one trip of delivery. Accordingly, efficiency in delivery from the provider to the predetermined place can be enhanced in comparison with when delivery responding to the request of the first user and delivery responding to the request of the second user are individually performed.

The delivery arrangement system may be configured to include: a second delivery request acceptance section that receives second delivery request information that requests delivery of the article to the predetermined place and is transmitted from the second user terminal in response to reception of the delivery offer information, and accepts a second delivery request that is a request made by the second user for delivery of the article to the predetermined place; and a delivery order placement section that, when the requests for delivery of the article to the predetermined place are accepted by the first delivery request acceptance section and by the second delivery request acceptance section, transmits, to a delivery management apparatus that manages delivery from the provider of the article to the predetermined place, delivery order placement information that places an order for delivery of the article from the provider to the predetermined place based on the first delivery request and delivery of the article from the provider to the predetermined place based on the second delivery request in association with each other.

According to such a configuration, the delivery order placement information that places the order for delivery of the article from the provider to the predetermined place based on the first delivery request and delivery of the article from the provider to the predetermined place based on the second delivery request in association with each other is transmitted by the delivery order placement section to the delivery management apparatus. Thus, the collective order for the deliveries to the same place requested by the different users can be placed with the provider of the article.

In the delivery arrangement system, when the provider is a mobile shop, the delivery offer section may be configured to acquire a condition used when delivery of the article is requested of a fixed shop by accessing a provider database in which information on the provider of the article is recorded, and to transmit to the second user terminal the delivery offer information including comparison information based on the acquired condition, on a cost or a delivery time period between making the second delivery request to the mobile shop and making the second delivery request to the fixed shop.

According to such a configuration, when the provider of the article is a mobile shop, by allowing the second user to realize a difference in cost or delivery time period between requesting delivery from the fixed shop and requesting delivery from the mobile shop, it is possible to prompt the second user to make a delivery request to the mobile shop.

In the delivery arrangement system, the predetermined place may be a charging station including a charging apparatus that can charge an electric vehicle, the first delivery request acceptance section may be configured to receive the first delivery request information from the first user terminal used by the first user that is an occupant of a first electric vehicle located in the charging station or heading for the charging station, and the second user extraction section may be configured to extract the second user that is an occupant of a second electric vehicle located in the charging station or heading for the charging station that is different from the first electric vehicle.

According to such a configuration, delivery of the articles to the charging station can be collectively performed for the first user and the second user that are expected to charge the electric vehicles in the same charging station at same timing.

In the delivery arrangement system, the delivery offer section may be configured to limitedly perform transmission of the delivery offer information to the second user terminal only when a time period of day during which the first delivery request is accepted is a predetermined time period of day that is set depending on a type of the article.

According to such a configuration, by limitedly performing transmission of the delivery offer information only when the first delivery request is accepted in the time period of day set depending on the type of the article (lunch hours from 11:30 to 13:00 when the type of the article is food and drink, or the like), it is possible to increase an appealing effect of the delivery offer to the second user.

In the delivery arrangement system, the delivery offer section may be configured to transmit to the second user terminal the delivery offer information including comparison information on a cost or a delivery time period between requesting delivery of the article based on the delivery offer information and requesting delivery of the article without using the delivery offer information.

According to such a configuration, by allowing the second user to realize a merit in terms of cost or delivery time period brought about when delivery is used in response to the delivery offer information, it is possible to prompt the second user to make a delivery request.

Another aspect to achieve the above-mentioned object can be a delivery arrangement method performed by a computer to arrange delivery of an article from a provider of the article to a predetermined place, including: a first delivery request acceptance step of, by the computer, receiving, from a first user terminal used by a first user located in the predetermined place or heading for the predetermined place, first delivery request information that requests delivery of the article to the predetermined place, and accepting a first delivery request that is a request made by the first user for delivery of the article to the predetermined place; a second user extraction step of, by the computer, extracting a second user located in the predetermined place or heading for the predetermined place when the first delivery request is accepted in the first delivery request acceptance step; and a delivery offer step of, by the computer, transmitting, to a second user terminal used by the second user extracted in the second user extraction step, delivery offer information that gives information related to delivery of the article to the predetermined place.

According to delivery arrangement as described above, when the request made by the first user for delivery of the article to the predetermined place is accepted in the first delivery acceptance step, delivery of the article to the predetermined place is offered to the second user located in the predetermined place or heading for the predetermined place in the delivery offer step. With the offer, a request made by the second user for delivery to the predetermined place can be accepted collectively with delivery to the predetermined place based on the already accepted request of the first user. The provider of the article can take an action of delivering the article requested by the first user and the article requested by the second user to the predetermined place in one trip of delivery. Accordingly, efficiency in delivery from the provider to the predetermined place can be enhanced in comparison with when delivery responding to the request of the first user and delivery responding to the request of the second user are individually performed.

According to the delivery arrangement system, when the request made by the first user for delivery of the article to the predetermined place is accepted by the first delivery request acceptance section, delivery of the article to the predetermined place is offered by the delivery offer section to the second user located in the predetermined place or heading for the predetermined place. With the offer, a request made by the second user for delivery to the predetermined place can be accepted collectively with delivery to the predetermined place based on the already accepted request of the first user. The provider of the article can take an action of delivering the article requested by the first user and the article requested by the second user to the predetermined place in one trip of delivery. Accordingly, efficiency in delivery from the provider to the predetermined place can be enhanced in comparison with when delivery responding to the request of the first user and delivery responding to the request of the second user are individually performed. The same applies to the delivery arrangement method.

### BRIEF DESCRIPTION OF THE DRAWINGS

FIG. 1 is a diagram for describing a configuration of a delivery arrangement system and an aspect of delivery arrangement;

FIG. 2 is a diagram for describing a user database;

FIG. 3 is a diagram for describing a vendor database;

FIG. 4 is a diagram for describing a received order database;

FIG. 5 is a flowchart of processing of collectively making arrangement for a delivery request from a first user and a delivery request from a second user; and

FIG. 6 is a diagram for describing a delivery offer screen.

### DETAILED DESCRIPTION OF THE PREFERRED EMBODIMENTS

### [1. Aspect of Delivery Arrangement by Delivery Arrangement System]

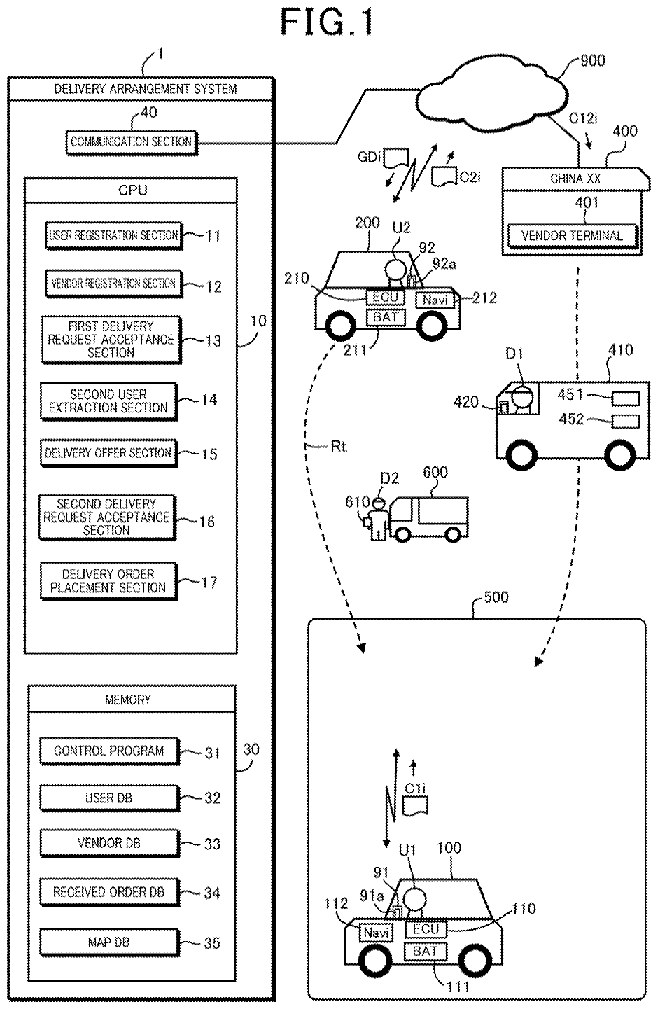

An aspect of delivery arrangement by a delivery arrangement system 1 according to the present embodiment will be described with reference to FIG. 1. FIG. 1 illustrates an aspect in which the delivery arrangement system 1 arranges delivery from a vendor 400 (corresponding to a fixed shop in the present invention) that is a provider of food and drink (corresponding to an article in the present invention) to a charging station 500 (corresponding to a predetermined place in the present invention), in response to requests from a first user U1 that is an occupant of a first electric vehicle 100 and from a second user U2 that is an occupant of a second electric vehicle 200. A charging apparatus (not shown) that can charge an electric vehicle is installed in the charging station 500.

The first electric vehicle 100 includes an ECU (Electronic Control Unit) 110 that controls entire operation of the first electric vehicle 100, a battery 111, and a navigation apparatus 112 that performs route guidance to a destination and the like. The first electric vehicle 100 is parked in the charging station 500 and charged. The second electric vehicle 200 also includes an ECU 210, a battery 211, and a navigation apparatus 112, similarly to the first electric vehicle 100. The second electric vehicle 200 travels along a route Rt toward the charging station 500.

The delivery arrangement system 1 collects a request for delivery to the charging station 500 made by the first user U1 and a request for delivery to the charging station 500 made by the second user U2, and collectively places an order with the vendor 400, in order to enhance efficiency in delivery of food and drink from the vendor 400 to the charging station 500. Thus, a first deliverer D1 of the vendor 400 can accomplish delivery of first food and drink 451 requested by the first user U1 and second food and drink 452 requested by the second user U2 in one trip.

### [2. Configuration of Delivery Arrangement System]

A configuration of the delivery arrangement system will be described with reference to FIGS. 1 to 4. As shown in FIG. 1, the delivery arrangement system 1 is a computer system including a CPU (Central Processing Unit) 10, a memory 30, a communication section 40, and the like.

The delivery arrangement system 1 performs communication, by using the communication section 40, with a vendor terminal 401 included in the vendor 400, a first deliverer terminal 420 used by the first deliverer D1 that performs delivery by using a delivery vehicle 410, a second deliverer terminal 610 used by a second deliverer D2 of a mobile catering vehicle 600 (corresponding to a mobile shop in the present invention), a first user terminal 91 used by the first user U1, and a second user terminal 92 used by the second user U2 through a communication network 900.

The memory 30 of the delivery arrangement system 1 stores a control program 31 for controlling the delivery arrangement system 1, a user DB (Data Base) 32 in which information on each user registered for use of the delivery arrangement system 1 is recorded, a vendor DB 33 (corresponding to a provider database in the present invention) in which information on each vendor registered for use of the delivery arrangement system 1 is recorded, a received order DB 34 in which order information on a delivery request made by each user is recorded, and a map DB 35.

The CPU 10 functions as a user registration section 11, a vendor registration section 12, a first delivery request acceptance section 13, a second user extraction section 14, a delivery offer section 15, a second delivery request acceptance section 16, and a delivery order placement section 17, by reading and executing the control program 31 stored in the memory 30.

Note that processing performed by the first delivery request acceptance section 13 corresponds to a first delivery request acceptance step in a delivery arrangement method according to the present invention, and processing performed by the second user extraction section 14 corresponds to a second user extraction step in the delivery arrangement method according to the present invention. Moreover, processing performed by the delivery offer section 15 corresponds to a delivery offer step in the delivery arrangement method according to the present invention, and processing performed by the second delivery request acceptance section 16 corresponds to a second delivery request acceptance step in the delivery arrangement method according to the present invention.

The user registration section 11 registers the first user U1 with the delivery arrangement system 1 by receiving user registration information transmitted from the first user terminal 91 and recording user information in the user DB 32. The user registration section 11 also registers other users such as the second user U2 with the delivery arrangement system 1 in a similar manner. A user registered with the delivery arrangement system 1 uses a delivery arrangement service rendered by the delivery arrangement system 1, by executing, on a user terminal, an application for making a delivery request provided by the delivery arrangement system 1.

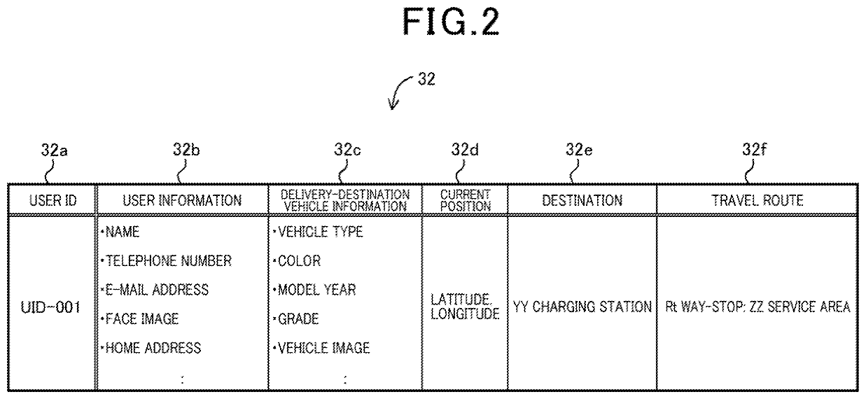

As shown in FIG. 2, in the user DB 32, a user ID 32a, a user information 32b, a delivery-destination vehicle information 32c, a current position 32d of a user or a delivery-destination vehicle, a destination 32e of the user, and a travel route 32f are recorded for each user. The user ID 32a is unique identification information issued to each user by the delivery arrangement system 1. The user information includes a name, a telephone number, an e-mail address, a face image, a home address, and the like of the user. The delivery-destination vehicle information 32c includes a vehicle type, a color, a model year, a grade, a vehicle image, and the like of the delivery-destination vehicle (a vehicle used by the user). The current position (a latitude, a longitude) is detected by the user terminal used by the user or a GPS (Global Positioning System) sensor (not shown) included in the vehicle with the user is on board.

The destination 32e and the travel route 32f are set on the user terminal or a navigation apparatus included in the vehicle with the user on board. The delivery arrangement system 1 recognizes the current position, the destination, and the travel route of the user or the vehicle with the user on board by performing communication with the user terminal or the navigation apparatus as appropriate, and updates records in the user DB 32.

The vendor registration section 12 registers the vendor 400 with the delivery arrangement system 1 by receiving vendor registration information transmitted from the vendor terminal 401 and recording vendor information in the vendor DB 33. A vendor registered with the delivery arrangement system 1 receives an order corresponding to a delivery request arranged by the delivery arrangement system 1, by executing, on the vendor terminal 401 used by the vendor, an application for receiving a delivery order provided by the delivery arrangement system 1. The vendor terminal 401 corresponds to a delivery management apparatus in the present invention that manages delivery of an article from the provider to the predetermined place.

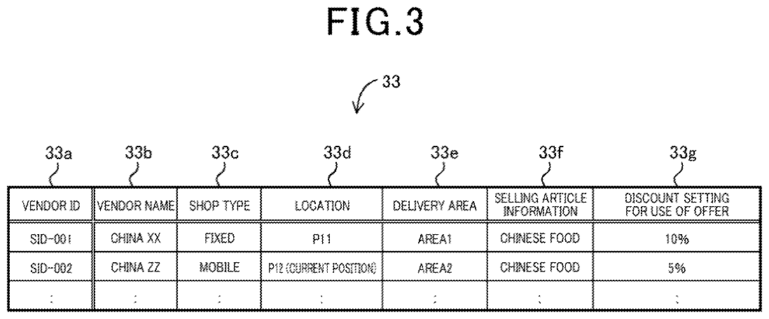

As shown in FIG. 3, in the vendor DB 33, a vendor ID 33a, a vendor name 33b, a shop type 33c, a location 33d, a delivery area 33e, selling article information 33f, and a discount setting 33g given when delivery is requested in response to a delivery offer, which will be described later, are recorded for each vendor. The vendor ID 33a is unique identification information issued to each vendor. The shop type 33c is either fixed (a fixed shop) or mobile (a mobile shop such as a mobile catering vehicle). The selling article information 33f includes a genre of deliverable articles dealt with by the vendor, a name, a content, and a price, and the like of each article.

When first delivery request information C1i transmitted from the first user terminal 91 is received, the first delivery request acceptance section 13 accepts a delivery request (first delivery request) made by the first user U1, by recording a content of the delivery request according to the first delivery request information C1i in the received order DB 34. In the example in FIG. 1, a request made by the first user U1 for delivery of the first food and drink 451 from the vendor 400 to the first electric vehicle 100 parked in the charging station 500 is accepted as a first delivery request by the first delivery request acceptance section 13.

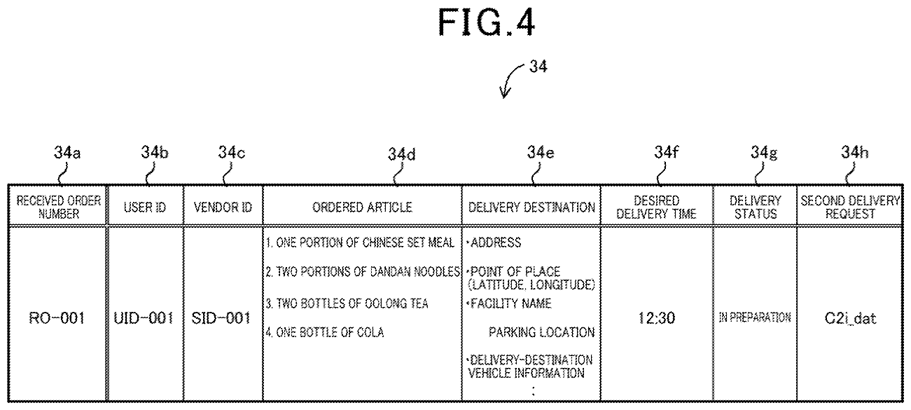

As shown in FIG. 4, in the received order DB 34, a received order number 34a, a user ID 34b, a vendor ID 34c, an ordered article 34d, a delivery destination 34e, a desired delivery time 34f, a delivery status 34g, and information on a second delivery request 34h, which will be described later, are recorded. The received order number 34a is issued by the delivery arrangement system 1 for each first delivery request accepted by the first delivery request acceptance section 13. The user ID 34b is a user ID of a first user that made a first delivery request, and the vendor ID 34c is a vendor ID of a vendor that is a provider of an article specified by the first delivery request.

The ordered article 34d is a list of ordered articles specified by the first delivery request, and the delivery destination 34e includes an address of a delivery destination specified by the first delivery request, a point of place (a latitude, a longitude), a facility name (YY charging station in the example in FIG. 1), a parking location (a slot or the like in a parking area in the YY charging station in the example in FIG. 1), and information (a vehicle type, a color, a license number, and the like) on a delivery-destination vehicle (the first electric vehicle 100 in the example in FIG. 1).

The desired delivery time is a desired delivery time specified by the first delivery request. The delivery status 34g is updated at any time in accordance with delivery status information transmitted from the vendor terminal 401 and the first deliverer terminal 420 to the delivery arrangement system 1. A content (similar to 34b to 34g) of a second delivery request is recorded in the second delivery request 34h.

When a first delivery request is accepted by the first delivery request acceptance section 13, the second user extraction section 14 searches for a second user heading for the charging station 500 by referring to the user DB 32 and the map DB 35. In the example in FIG. 1, the second user U2 heading for the charging station 500 by using the route Rt is extracted. In the event, along with the second user moving toward the charging station 500 as a destination, a second user heading for a final destination via the charging station 500 is also extracted as a second user heading for the charging station 500.

Here, respective destinations of the first user and the second user do not need to be perfectly identical. For example, regarding different destinations of a plurality of users, when the destination of a user is on a route of delivery of an article to the destination of a first user that is farthest from a provider of the article, the user may be extracted as a second user.

When the second user U2 is extracted by the second user extraction section 14, the delivery offer section 15 transmits, to the second user terminal 92, delivery offer information GDi that offers delivery of food and drink from the vendor 400 to the charging station 500. The second delivery request acceptance section 16 receives second delivery request information that requests delivery of food and drink from the vendor 400 to the charging station 500 in response to reception of the delivery offer information GDi. The second delivery request acceptance section 16 accepts a second delivery request that is a request made by the second user U2 for delivery of second food and drink from the vendor 400 to the charging station 500, by additionally recording a content C2i_dat of the second delivery request information C2i in the received order DB 34.

The delivery order placement section 17 refers to the received order DB 34 and transmits, to the vendor terminal 401, delivery order placement information Cl2i in which the first delivery request made by the first user U1 for requesting delivery of food and drink from the vendor 400 to the charging station 500 and the second delivery request triggered by the first delivery request and made by the second user U2 are associated with each other (collected). The delivery order placement information Cl2i includes information on the first delivery request according to 34a to 34f and information on the second delivery request according to 34h as shown in FIG. 4.

[3. Processing Performed when Delivery Request from First User is Accepted]

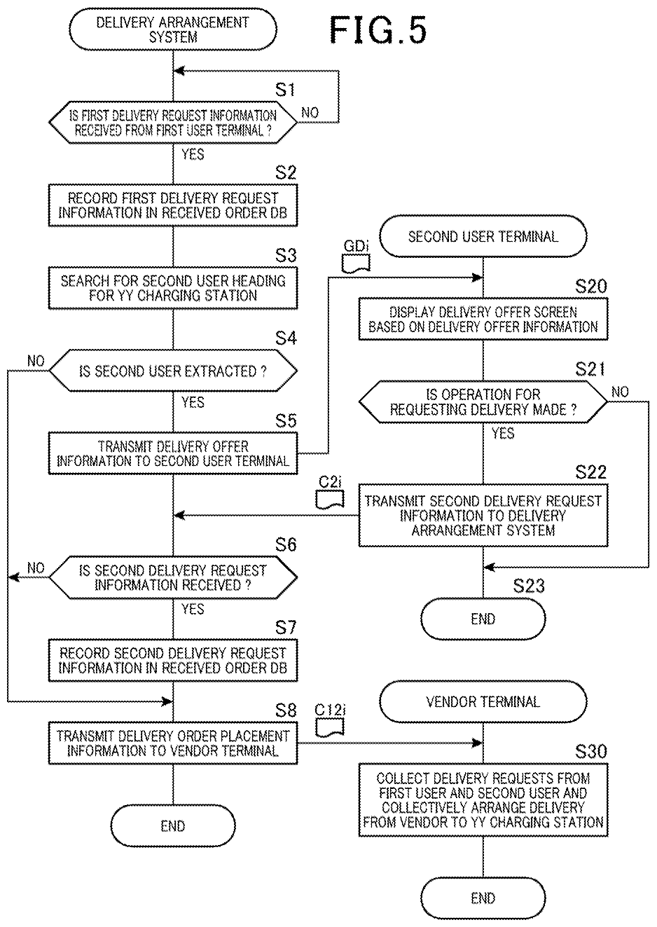

A description will be given, by following a flowchart shown in FIG. 5, of processing performed by the delivery arrangement system 1 when, under a situation as shown in FIG. 1, the first user U1 requests delivery of the first food and drink 451 from vendor 400 to the charging station 500 (more specifically, the first electric vehicle 100 parked in the charging station 500) by operating the first user terminal 91.

In step S1 in FIG. 5, when the first delivery request information C1i is received from the first user terminal 91, the first delivery request acceptance section 13 advances the processing to step S2. In step S2, the first delivery request acceptance section 13 records a content of the received first delivery request information C1i in the received order DB 34 and thus accepts a first delivery request that is a request made by the first user U1 for delivery of the first food and drink 451 from the vendor 400 to the charging station 500.

In subsequent step S3, the second user extraction section 14 searches for a second user heading for the charging station 500 by referring to the user DB 32 and the map DB 35. In subsequent step S4, the second user extraction section 14 advances the processing to step S5 when the second user is extracted, and advances the processing to step S8 when the second user is not extracted. In the example in FIG. 1, since the second user U2 is extracted, the second user extraction section 14 advances the processing to step S5. In step S5, the delivery offer section 15 transmits to the second user terminal 92 the delivery offer information GDi that offers delivery of food and drink from the vendor 400 to the charging station 500.

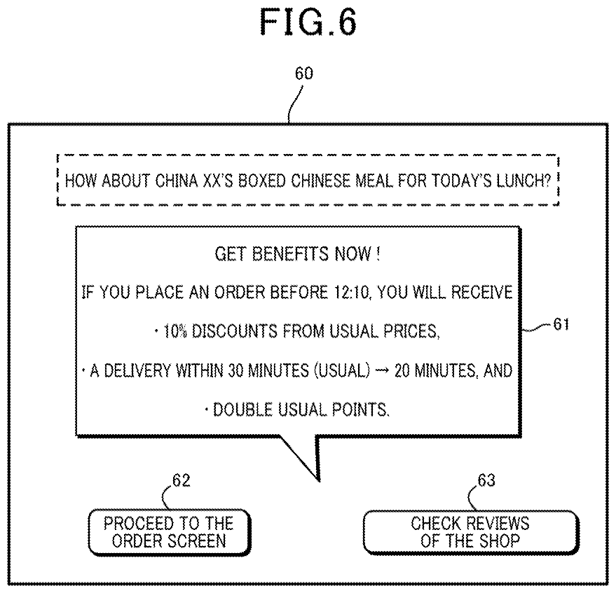

The second user terminal 92 having received the delivery offer information GDi displays a delivery offer screen based on the delivery offer information GDi on a touch panel 92a in step S20. As shown in FIG. 6, a merit informing display 61, which shows cost and temporal merits in making a delivery request in response to the delivery offer information GDi in comparison with when ordinary delivery is performed not via the delivery offer information GDi, is rendered in a delivery offer screen 60. With the merit informing display 61, it is possible to show an advantage of making a delivery request via the offer and thus to prompt the second user U2 to make a delivery request.

In subsequent step S21, the second user terminal 92 advances the processing to step S22 when an operation for requesting delivery is made by the second user U2, and advances the processing to step S23 when an operation for requesting delivery is not made by the second user U2. In step S22, the second user terminal 92 transmits the second delivery request information C2i that requests delivery of the second food and drink 452 from the vendor 400 to the charging station 500 (more specifically, the second electric vehicle 200 that will arrive at the charging station 500 in a while).

In the delivery arrangement system 1, in step S6, the second delivery request acceptance section 16 advances the processing to step S7 when the second delivery request information C2i is received from the second user terminal 92, and advances the processing to step S8 when the second delivery request information C2i is not received. In step S7, the second delivery request acceptance section 16 records a content of the second delivery request information C2i in the received order DB 34 and thus accepts a second delivery request that is a request made by the second user U2 for delivery of the second food and drink 452 from the vendor 400 to the charging station 500.

In subsequent step S8, the delivery order placement section 17 transmits to the vendor terminal 401 the delivery order placement information C12i in which the first delivery request accepted by the first delivery request acceptance section 13 in step S2 and the second delivery request accepted by the second delivery request acceptance section 16 in step S7 are collected. A content of the delivery order placement information C12i is an instruction to collectively perform delivery of the first food and drink 451 to the charging station 500 based on the first delivery request and delivery of the second food and drink 452 to the charging station 500 based on the second delivery request.

The vendor terminal 401 having received the delivery order placement information C12i from the delivery arrangement system 1 transmits, to the first deliverer terminal 420, delivery instruction information that instructs to collectively transport the first food and drink 451 and the second food and drink 452 to the charging station 500 and to deliver the first food and drink 451 and the second food and drink 452 to the first electric vehicle 100 parked in the charging station 500 and the second electric vehicle 200 arriving at the charging station 500, in step S30.

The first deliverer D1 confirms the delivery instruction information, puts the first food and drink 451 and the second food and drink 452 in the delivery vehicle 410, and performs delivery from the vendor 400 to the charging station 500. Delivery of the first food and drink 451 and the second food and drink 452 is accomplished in one trip in such a manner, whereby efficiency in delivery can be enhanced in comparison with when the first food and drink 451 and the second food and drink 452 are individually delivered in two trips.

Although FIG. 1 shows a case where one second user U2 is extracted as a second user, a large number of second users heading for the charging station 500 may be extracted, and second delivery requests may be made by the large number of second users, whereby efficiency in delivery between the vendor 400 and the charging station 500 can be further enhanced.

### [4. Other Embodiments]

Although a description is given in the above-described embodiment of a case where the first delivery request made by the first user U1 is addressed to the vendor 400 that is a fixed shop, the delivery arrangement system 1 also seeks to enhance efficiency in delivery by performing similar processing when the first delivery request made by the first user U1 is addressed to a mobile catering vehicle 600 that is a mobile shop. In such a case, the second deliverer terminal 610 used by the second deliverer D2 corresponds to a vendor terminal in the present invention, and delivery order placement information is transmitted from the delivery arrangement system 1 to the second deliverer terminal 610.

When a delivery request is made to the mobile catering vehicle 600, the delivery offer section 15 searches for a fixed shop that deals with delivery of a same type of article as an article ordered according to the first delivery request by accessing the vendor DB 33, and thus can acquire conditions (a cost, a delivery time period, and the like) used when delivery of the article is requested of a fixed shop. The delivery offer section 15 may be configured to transmit to the second user terminal 92 the delivery offer information GDi including comparison information indicating a cost or temporal merit in requesting delivery from the mobile catering vehicle 600 in comparison with requesting delivery from a fixed shop. Thus, an offer screen showing the cost or temporal merit in requesting delivery from the mobile catering vehicle 600 is displayed on the touch panel 92a of the second user terminal 92, whereby it is possible to allow the second user U2 to realize an advantage in making a request to the mobile catering vehicle 600 that is located near to the charging station 500 and to prompt the second user U2 to make a delivery request to the mobile catering vehicle 600.

Although the cost and temporal merits in making a delivery request in response to a delivery offer in comparison with making an ordinary delivery request without using the delivery offer are displayed in the delivery offer screen 60 as shown in FIG. 6 in the above-described embodiment, a merit in terms of only any one of cost and time may be displayed. Effects of the present invention can also be achieved when a merit is not displayed.

Although the charging station 500 is illustrated in the above-described embodiment as an example of the predetermined place in the present invention, the predetermined place may be any place that is large in area to some degree and where people gather, such as a shopping center, an office building, or a leisure facility.

A time period of day during which the vendor 400 of food and drink as in the above-described embodiment receives delivery requests is expected to concentrate on lunch hours and the like. Accordingly, transmission of the delivery offer information GDi to second users U2 is limitedly performed in a predetermined time period of day (for example, within a time range of 11:30 to 13:00) during which delivery is expected to concentrate, whereby it is possible to efficiently receive an order corresponding to delivery requests from second users U2. In such a manner, the predetermined time period of day is set depending on a type of an article to be delivered. In evening meal hours (for example, 18:00 to 20:00), transmission of the delivery offer information GDi to second users U2 may also be performed.

For the first user terminal 91 used by the first user U1, the second user terminal used by the second user U2, and the second deliverer terminal 610 used by the second deliverer D2, although communication terminals of a portable type (a smartphone, a mobile telephone, a tablet terminal, and the like) are illustrated in the above-described embodiment, such terminals may be mounted in vehicles.

Although the first user U1 that moves by boarding the first electric vehicle 100 and the second user U2 that moves by boarding the second electric vehicle 200 are illustrated in the above-described embodiment, the present invention can also be applied when the first user and the second user move by boarding vehicles using fuel such as gasoline vehicles or by using public transport such as trains, or move on foot.

Note that FIG. 1 is a schematic diagram showing functional components of the delivery arrangement system 1 that are divided by main content of processing in order to facilitate understanding of the invention of the present application, and the components of the delivery arrangement system 1 may be arranged based on other divisions. Processing by each constitutional element may be performed by a single hardware unit, or may be performed by a plurality of hardware units. The processing by each constitutional element may be performed by a single program, or may be performed by a plurality of programs.

### REFERENCE SIGNS LIST

1 . . . Delivery arrangement system, 10 . . . CPU, 11 . . . User registration section, 12 . . . Vendor registration section, 13 . . . First delivery request acceptance section, 14 . . . Second user extraction section, 15 . . . Delivery offer section, 16 . . . Second delivery request acceptance section, 17 . . . Delivery order placement section, 30 . . . Memory, 31 . . . Control program, 32 . . . User DB, 33 . . . Vendor DB, 34 . . . Received order DB, 35 . . . Map DB, 40 . . . Communication section, 60 . . . Delivery offer screen, 91 . . . First user terminal, 92 . . . Second user terminal, 100 . . . First electric vehicle, 200 . . . Second electric vehicle, 400 . . . Vendor, 401 . . . Vendor terminal, 410 . . . Delivery vehicle, 420 . . . First deliverer terminal, 451 . . . First food and drink, 452 . . . Second food and drink, 500 . . . Charging station, 600 . . . Mobile catering vehicle, 610 . . . Second deliverer terminal, 900 . . . Communication network, U1 . . . First user, U2 . . . Second user, D1 . . . First deliverer, D2 . . . Second deliverer

What is claimed is:

1. A delivery arrangement system that arranges delivery of an article from a provider of the article to a predetermined place, comprising:
a first delivery request acceptance section that receives, from a first user terminal used by a first user located in the predetermined place or heading for the predetermined place, first delivery request information that requests delivery of the article to the predetermined place, and accepts a first delivery request that is a request made by the first user for delivery of the article to the predetermined place;
a second user extraction section that extracts a second user located in the predetermined place or heading for the predetermined place when the first delivery request is accepted by the first delivery request acceptance section; and
a delivery offer section that transmits, to a second user terminal used by the second user extracted by the second user extraction section, delivery offer information that gives information related to delivery of the article to the predetermined place.

2. The delivery arrangement system according to claim 1, comprising:
a second delivery request acceptance section that receives second delivery request information that requests delivery of the article to the predetermined place and is transmitted from the second user terminal in response to reception of the delivery offer information, and accepts a second delivery request that is a request made by the second user for delivery of the article to the predetermined place; and
a delivery order placement section that, when the requests for delivery of the article to the predetermined place are accepted by the first delivery request acceptance section and by the second delivery request acceptance section, transmits, to a delivery management apparatus that manages delivery from the provider of the article to the predetermined place, delivery order placement information that places an order for delivery of the article from the provider to the predetermined place based on the first delivery request and delivery of the article from the provider to the predetermined place based on the second delivery request in association with each other.

3. The delivery arrangement system according to claim 2, wherein when the provider is a mobile shop, the delivery offer section acquires a condition used when delivery of the article is requested of a fixed shop by accessing a provider database in which information on the provider of the article is recorded, and transmits to the second user terminal the delivery offer information including comparison information based on the acquired condition, on a cost or a delivery time period between making the second delivery request to the mobile shop and making the second delivery request to the fixed shop.

4. The delivery arrangement system according to claim 1, wherein the predetermined place is a charging station including a charging apparatus that can charge an electric vehicle,
the first delivery request acceptance section receives the first delivery request information from the first user terminal used by the first user that is an occupant of a first electric vehicle located in the charging station or heading for the charging station, and
the second user extraction section extracts the second user that is an occupant of a second electric vehicle located in the charging station or heading for the charging station that is different from the first electric vehicle.

5. The delivery arrangement system according to claim 1, wherein the delivery offer section limitedly performs transmission of the delivery offer information to the second user terminal only when a time period of day during which the first delivery request is accepted is a predetermined time period of day that is set depending on a type of the article.

6. The delivery arrangement system according to claim 1, wherein the delivery offer section transmits to the second user terminal the delivery offer information including comparison information on a cost or a delivery time period between requesting delivery of the article based on the delivery offer information and requesting delivery of the article without using the delivery offer information.

7. A delivery arrangement method performed by a computer to arrange delivery of an article from a provider of the article to a predetermined place, comprising:
a first delivery request acceptance step of, by the computer, receiving, from a first user terminal used by a first user located in the predetermined place or heading for the predetermined place, first delivery request information that requests delivery of the article to the predetermined place, and accepting a first delivery request that is a request made by the first user for delivery of the article to the predetermined place;
a second user extraction step of, by the computer, extracting a second user located in the predetermined place or heading for the predetermined place when the first delivery request is accepted in the first delivery request acceptance step; and
a delivery offer step of, by the computer, transmitting, to a second user terminal used by the second user extracted in the second user extraction step, delivery offer information that gives information related to delivery of the article to the predetermined place.
